(19) United States
(12) Patent Application Publication
(10) Pub. No.: US 2012/0091944 A1
(43) Pub. Date: Apr. 19, 2012

(54) JUMP START ADAPTER

(76) Inventor: Chad Rogers, Baird, TX (US)

(21) Appl. No.: 13/162,555

(22) Filed: Jun. 16, 2011

Related U.S. Application Data
(60) Provisional application No. 61/394,395, filed on Oct. 19, 2010.

(51) Int. Cl. H02J 7/00; B60L 1/00

(52) U.S. Cl. 320/105; 307/150; 307/9.1

(57) ABSTRACT

An apparatus for providing a low cost, quick, and convenient automobile jump starting system and method. The jump start system comprises an adapter suitable to receive at least one hand held power tool battery. The adapter in certain embodiments comprises conductive metallic spring clips for making electrical connection(s) between the tool battery and the adapter. The adapter further comprises a plurality of connectible gauge wires (serving as booster cables) each having biasing connectors (alligator clips). The distal ends of the gauge wire(s) may be removably connectible to the adapter or may be rigidly fixed to the adapter. The Jump Start Adapter System may also be removably connected to the vehicle battery using biasing connectors or may be hard wired to the vehicle electrical system eliminating the need for biasing connectors. The proximate end(s) of the connectible gauge wire(s) comprise the biasing connectors for making connection to the dead battery of the vehicle when using a free-standing jump start adapter system. One of the connectible gauge wires is a red color-coded eight-gauge wire serving as a positive cable and the other connectible gauge wires is a black color-coded eight-gauge wire serving as a negative cable. The Jump Start Adapter system of the present invention allows individuals to jump-start various types of vehicle engines using a rechargeable battery from a power tool battery.

### CROSS-REFERENCE TO RELATED APPLICATION

The present application is related to and claims priority from prior provisional application Ser. No. 61/394,395, filed Oct. 19, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of battery boosting systems and more specifically relates to a jump start adapter for use in boosting dead batteries in vehicles using a power hand tool battery.

2. Description of the Related Art

Many people in modern society use vehicles to transport themselves and others between locations. These vehicles are often powered by internal combustion engines. Batteries may be used to start these engines. When the battery of a vehicle is drained, it is most often necessary to jump-start the engine using power from another battery. Jumper cables may be used to connect the two vehicle batteries in series to boost the dead battery. Traditionally, jumper cables are identified by black (−) and red (+) handles, representing the two polarities of the automobile's direct current system, indicating how to properly hook the cables to the batteries. When there is not a second vehicle available, and the driver does not have a 12 volt direct voltage auxiliary starting system, then the driver can lose precious hours out of their day waiting for assistance to show up. These situations usually occur at the most inconvenient of times causing the owner of the vehicle to miss or be late to important events in life; such as job interviews, business meeting, or children's activities.

The automobile's alternator normally recharges the battery as the internal combustion engine runs so that the car is ready for the next start. When an electrical device is left on or plugged in it can drain volts out of the vehicles battery just below the level necessary to start the engine without an extra boost. The vehicle will remain disabled since the starter doesn't have the supplied power to “turn over” the motor. Additionally, purchasing a 12 volt direct current voltage auxiliary starting system for such an occasion can be expensive and take up valuable storage space. A need exists for a convenient, inexpensive, and easy to store solution.

Various attempts have been made to solve the above-mentioned problems such as those found in U.S. Pat. and Pub. Nos. 6,562,509; 6,007,373; 5,076,805; 7,309,928; 2005/0156564; and D474,151. This prior art is representative of vehicle jump start means and methods. None of the above inventions and patents, taken either singly or in combination, is seen to describe the invention as claimed.

Ideally, a jump start adapter should be user friendly and safe in-use yet, would operate reliably and be manufactured at a modest expense. Thus, a need exists for a reliable, convenient automobile jump start system to jump start vehicles with dead batteries and to avoid the above-mentioned problems.

### BRIEF SUMMARY OF THE INVENTION

In view of the foregoing disadvantages inherent in the known automobile battery boosting art, the present invention provides a novel automobile jump start system. The general purpose of the present invention, which will be described subsequently in greater detail, is to provide a low cost, quick, and convenient automobile jump starting system.

A jump start system is disclosed herein comprising: an adapter suitable to receive at least one tool battery; wherein the adapter comprises a plastic housing and preferably comprises a freestanding unit suitable to store and use in the event of a vehicle battery requiring a ‘boost’. The tool battery preferably comprises a rechargeable dry cell battery. In a preferred embodiment the adapter comprises contacts for making electrical connection(s) between the tool battery and the adapter. The present invention further comprises a plurality of connectible gauge wires (serving as booster cables) each having a proximate and a distal end. The device may further comprise two biasing connectors each having an alligator clip. The tool battery comprises a portable tool powerer such as those found in portable drills, saws, and other such tools. The distal end(s) of the connectible gauge wire(s) may be removably connected to the adapter or in other embodiments may be rigidly affixed.

The proximate end(s) of the connectible gauge wire(s) comprise the biasing connectors to biasingly connect the adapter via the removably connectible gauge wire(s) to the battery (acting as clamping booster cable ends.) In preferred embodiments these connectible gauges comprise a red color-coded eight-gauge wire serving as a positive cable and a black color-coded eight-gauge wire serving as a negative cable, allowing the user to readily discriminate which wire and clamp gets hooked to which battery post. The vehicle battery comprises a rechargeable wet cell battery.

The jump start system may further comprise a kit as described herein including the adapter, optionally a tool battery (boosting power-supply means), connectible gauge wires, alligator clips, and an instruction manual.

A method for using the jump start system is also described herein comprising the steps of: boosting a tool battery; inserting the tool battery into an adapter; connecting a first connectible gauge wire acting as a positive cable from the adapter to a positive battery terminal; next connecting a second connectible gauge wire acting as a negative cable from the adapter to a negative battery terminal; boosting a vehicle battery using stored potential chemical energy from the tool battery; and disconnecting the first and second connectible gauge wires from the positive and negative battery terminals respectively.

The present invention holds significant improvements and serves as an automobile jump starting system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Jump Start Adapter, constructed and operative according to the teachings of the present invention.

FIG. 1 is a perspective view illustrating a vehicle starting device entitled Jump Start Adapter according to an embodiment of the present invention.

FIG. 2 is a perspective view illustrating the jump start adapter in an in-use condition according to an embodiment of the present invention of FIG. 1.

FIG. 3 is another perspective view illustrating the jump start adapter according to an embodiment of the present invention of FIG. 1.

FIG. 4 is another perspective view illustrating the jump start adapter according to another embodiment of the present invention of FIG. 1.

FIG. 5 is a flowchart illustrating a method of use for the jump start adapter according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a vehicle starting device 102 and more particularly to a jump start adapter system 100 as used to improve the convenience of starting an engine of vehicle 150 with an uncharged battery 160. It should be appreciated that the described invention will not work successfully in all instances if the alternator is not working properly. It should also be appreciated that if the charging system is not in good working condition (i.e. dirty, corroded, or loose electrical connections) then the described invention may not work successfully every time.

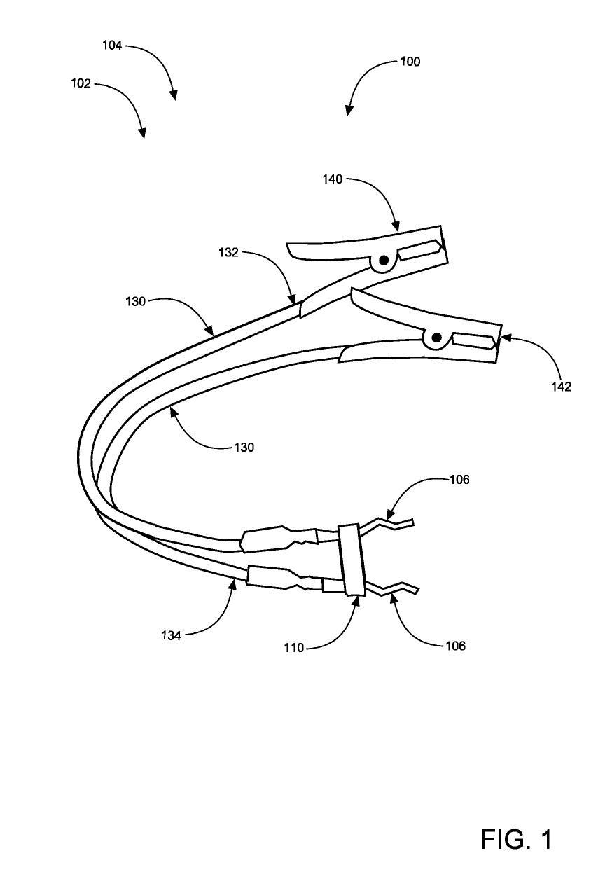

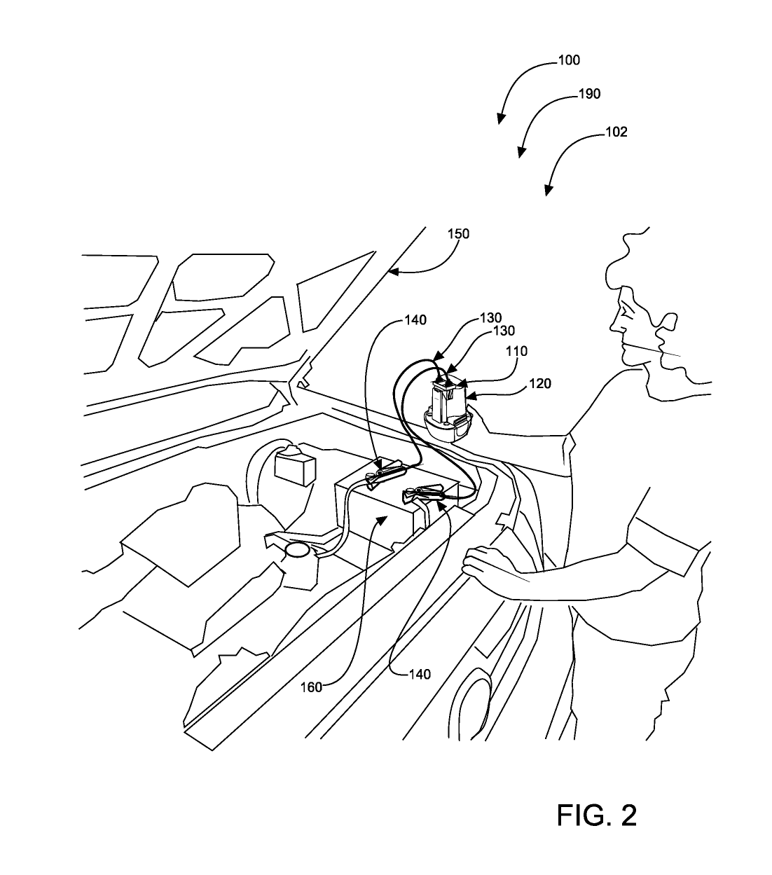

Referring now to FIGS. 1 and 2 showing perspective views illustrating vehicle starting device 102 entitled “Jump Start Adapter” 104 in FIG. 1 and FIG. 2 illustrating jump start adapter 104 in an in-use condition 190 according to an embodiment of the present invention of FIG. 1.

Jump start system 100, as shown comprises: at least one adapter 110 suitable to receive at least one tool battery 120; adapter 110 preferably comprising contacts for making electrical connection(s) between tool battery 120 and adapter 110. Jump start system 100 preferably comprises a plurality of removably connectible gauge wires 130 each having a proximate end 132 and distal end 134; at least one biasing connector 140; wherein distal end(s) 134 of removably connectible gauge wire(s) 130 are removably or non-removably connected to adapter 110. Gauge wire(s) 130 and biasing connectors 140 in combination serve to work in the capacity of ‘booster cables’. Adapter 110 may also comprise biasing means whereby removably connectible gauge wire(s) 130 are temporarily secured to contacts on tool battery 120 to provide necessary coupling force to limit electrical resistance to flow.

Proximate end(s) 132 of removably connectible gauge wire(s) 130 preferably comprise biasing connectors 140 to biasingly connect adapter 110 via removably connectible gauge wire(s) 130 to battery 160. In this way the present invention is able to communicate electrical flow to boost battery 160. Jump start adapter system 100 is thereby usable to jump-start battery 160 to ‘turn over’ an engine such as an internal combustion engine. Engines that may be boosted by the present invention include movable land vehicles 150 and/or versions of non-movable land vehicles and/or non-land vehicles.

Tool battery 120 preferably comprises a portable tool powerer within this preferred embodiment. Tool battery 120 comprises a rechargeable dry cell battery as may be found in portable industrial tools. To promote portability and convenience, adapter 110 may comprise a freestanding (stand-alone) unit that can be carried to and from various locations. The feature of tool battery 120 being lightweight provides that men and women are able to easily carry the device between locations, as compared to traditional 12 volt direct current voltage systems.

Alternately, adapter 110 may be hardwired into movable land vehicle 150. Adapter 110 may be hardwired directly/indirectly to battery 160 located in movable land vehicle 150. It is preferred that adapter 110 comprise an aesthetic appearance and/or be hidden from view. Alternately, adapter 110 may be hardwired to a starter motor located in movable land vehicle 150. Vehicle battery 160 may comprise a rechargeable wet cell battery 160 in typical circumstances, however it should be appreciated that other types of batteries may also be boosted.

In certain embodiments, adapter 110 may be used in the following way(s): removably hooking removably connectible gauge wire(s) 130 to tool battery 120 and removably hooking biasing connectors 140 to battery 160 (may comprise various configurations to facilitate the use of various types of tool batteries 120 as made by different manufacturers.) In other (hard-wired) embodiments, adapter 110 may comprise a housing that receives tool battery 120 (already having biasing connectors 140 connected thereto.) Adapter 110 of jump start adapter system 100 preferably comprises a plastic housing within these particular embodiments. More on the use of the present invention is detailed subsequently.

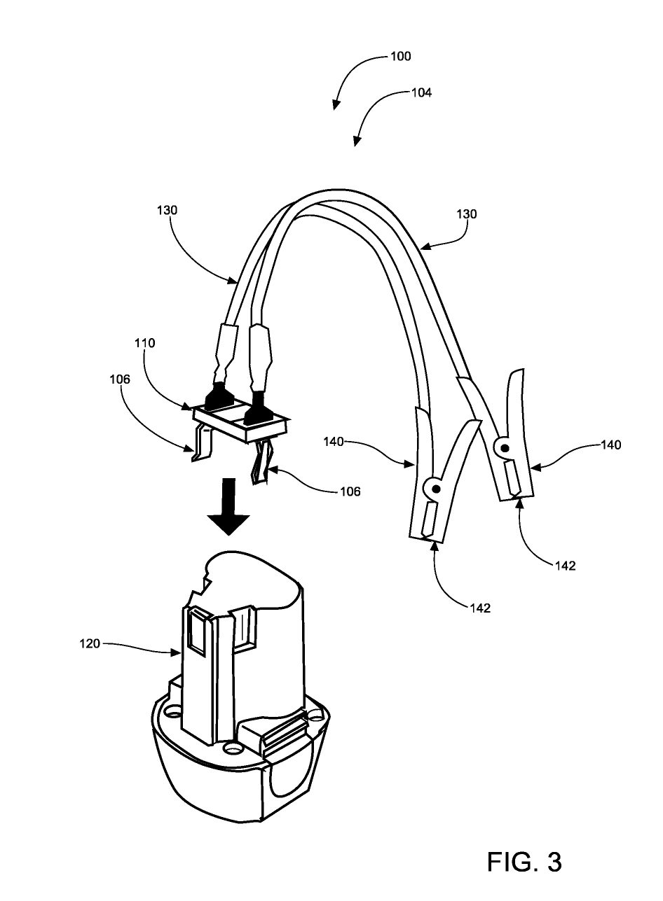

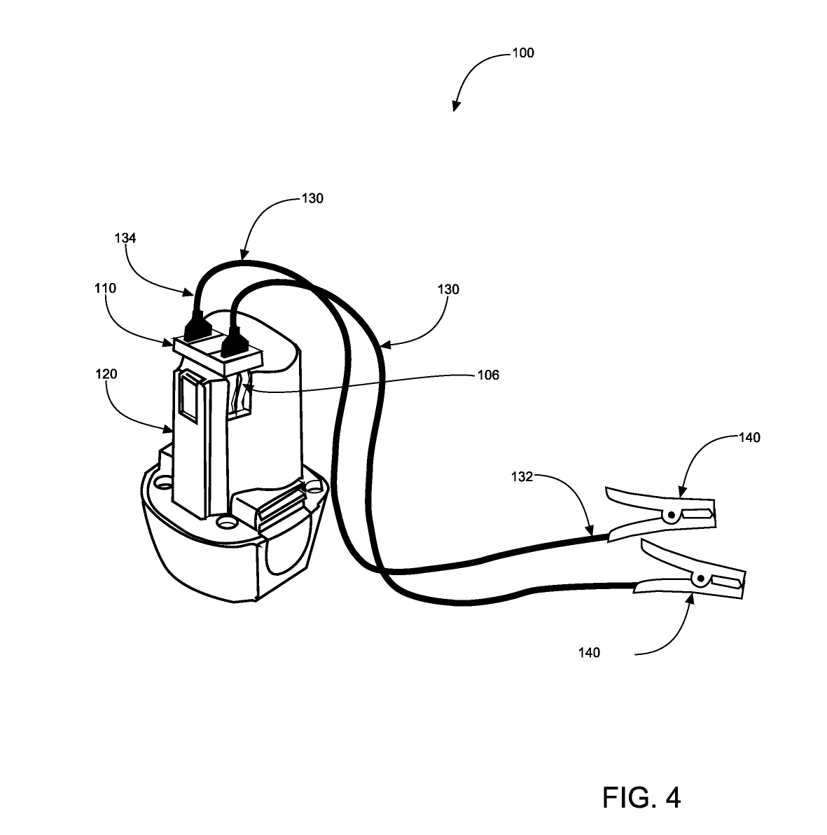

Referring now to FIGS. 3 and 4 showing perspective views illustrating jump start adapter 104 according to an embodiment of the present invention of FIG. 1.

The present invention is made substantially safe for in-use condition 190 by making removably connectible gauge wire(s) 130 comprising a red color-coded version of eight-gauge wire serving as a positive cable and a black color-coded eight-gauge wire serving as a negative cable (at least herein embodying versions of removably connectible gauge wire(s) 130). At least one of biasing connector(s) 140 comprises at least one clip (clamping means). Clamping means may comprise a red color-coded alligator clip and a black color-coded alligator clip. Color coding between removably connectible gauge wire(s) 130 and biasing connector(s) 140 is matched (black-to-black and red-to-red). It should be appreciated that virtually any gauge wire that will handle the amps used may be sufficient. Eight gauge has been specified as an enablement means because it is large enough to handle the amps without over-heating, yet small enough to be flexible. Smaller or larger gauge wire(s) may be used and still achieve substantially equivalent results. Further, other biasing means other than alligator clips may also be used to ‘clip’ the device for use.

When battery 160 of vehicle 150 is drained, it is most often necessary to start the engine using volts from another battery 160. Jumper cables connect batteries 160 from two separate vehicle(s) 150 together so that one battery 160 may supply volts to the other. However, in the event that there is not a second battery 160 available, another option is now made available via the present invention as discussed herein. Jump Start Adapter 104 comprises a device designed to start vehicle engines using a battery 160 from a power tool. In the event that a car's battery 160 becomes drained, users may take this adapter 110 and combine it (hook it) with tool battery 120, such as a drill, flashlight, skill saw, and more to provide a viable jump-starting means. Fully charged power tool battery 120 may alternately be receivedly-inserted into adapter 110, the device can then be used to jump-start the engine using either embodiment.

Jump Start Adapter 104 of the present invention allows individuals to jump-start a vehicle 150 engine using a power tool battery 120, as mentioned previously. The invention is preferably comprised of an adapter 110 with contacts that make connections to a battery 160 from a power tool battery 120, a red eight-gauge version of removably connectible gauge wire 130, a black eight-gauge version of removably connectible gauge wire 130 wire, a red alligator clip(s) 142 and a black alligator clip(s) 142. In this way the present invention is made both substantially safe for use and efficient in use since the user can easily differentiate the hooking up procedure without tracing the wires.

The user may take a fully charged tool battery 120 from a power tool, such as a drill or saw, and plug it into an adapter 110. They may then take the wires running from the adapter 110 and hook the red removably connectible gauge wire 130 to the positive post or terminal on the car and hook the black removably connectible gauge wire 130 to the negative post or terminal in order to jump-start the engine (in that preferred respective order.) This device may also be used to jump-start other engines that have been drained of power, until power has been depleted below a threshold level. The adapter 110 may be hardwired into virtually any vehicle 150 or it may be a freestanding unit, as discussed above. Alternately, the invention may comprise a reusable adapter 110 with two electrically conductive metallic spring clips 106 for connecting to a rechargeable hand held power tool battery 120. In this way adapter 110 may take various forms, yet still provide the required function. Removably connectible gauge wire(s) 130 connected to the adapter 110 may be of various lengths to be used in various conditions. The removably connectible gauge wire(s) 130 may be color coded red for positive polarity and black for negative polarity. When in use, adapter 110 is oriented so that the red removably connectible gauge wire 130 is connected to the positive contact on the rechargeable tool battery 120 and the black contacting the negative contact of the rechargeable tool battery 120. Clamps connected to the wires may also have a non-conductive insulation colored to match the insulation of the wire it is connected to.

To enable the instant invention in a multitude of ways the following is provided:

First application for use of jump start adapter system 100:

Freestanding adapter 110 with a fully charged tool battery 120 from a battery operated power tool (ie drill, skill saw, light, etc.).

Second application for use of jump start adapter system 100:

Adapter 110 may be hardwired into the battery 160 of the vehicle 150 or engine and is preferably mounted in a convenient location on vehicle 150 or engine (firewall/engine bay or other).

Third application for use of jump start adapter system 100:

Adapter 110 may be hardwired into the starter of vehicle 150 or engine and have adapter 110 mounted in a convenient (unobtrusive) location.

First application—Use one for jump start adapter system 100:

Take a fully charged tool battery 120 from a battery operated power tool and connect adapter 110 to the fully charged tool battery 120. Hook-up of previous step is done in the same manner/fashion that a user would hook up a drill to a fully charged tool battery 120 or any other rechargeable tool. Next, the user transports/carries adapter 110 and tool battery 120 to vehicle 150 or engine that needs a boost and connects the proximate end 132 of adapter to the dead battery 160 located in vehicle 150. The other end of adapter 110 has two removably connectible gauge wire(s) 130 coming out of it with alligator clips 142 on it. Next connect alligator clips 142 to corresponding post on dead battery 160. Then start vehicle 150 or engine by using volts from fully charged tool battery 120 and amps from vehicle battery 160 to turn over the engine.

First application—Use two for jump start adapter system 100:

Take adapter 110 and fully charged tool battery 120 and connect adapter 110 to conductive contacts on tool battery 120. Then this adapter 110 could be used as a tool by anyone to check and see if certain parts, new or used, are good. For example, when you buy a starter from an auto-parts store, either the employee or the customer could take adapter 110, hook it up to starter and see if the starter works before purchasing it and taking it home.

Second application—Use one for jump start adapter system 100:

Take adapter 110 and instead of putting alligator clips 142 on it, hardwire that end to battery 160 and then mount adapter 110 housing in a convenient location. Then if vehicle 150 or engine needs a boost then only thing needed is fully charged tool battery 120 to be plugged into adapter 110; which helps to serve people with little or no mechanical knowledge. They wouldn't have to worry about hooking alligator clips 142 up wrong. It should be appreciated that after uses tool battery 120 should be adequately recharged.

Third application—Use one for jump start adapter system 100:

Take adapter 110 and hardwire it to starter instead of battery 160 so that you could eliminate vehicle 150 or engine battery 160 all together such as on an ATV, motorcycle, dirt bike, lawnmower, etc, almost any small engine. The object is to have adapter 110 in a convenient location and take a fully charged tool battery 120 from a battery operated power tool and plug into adapter 110 and start vehicle 150.

Explanation of how and why this works as a further means of enablement: vehicle 150 with a properly working charging system that has a dead battery 160 because something was left on or plugged in needs a boost to get started, as discussed above. In most cases the device that was left on or plugged-in drained voltage but not many amps. Volts are what works electrical devices and amperage (amps) is the power in volts. Most electrical devices on vehicle(s) 150 use very little amps. The one component that uses considerable amps is the vehicle 150 starter. What normally happens is when something is left on or plugged in and drains the battery 160 is the operator attempts to crank vehicle 150 engine and he/she hears a clicking noise, or in most newer vehicle(s) 150, you turn the key and nothing at all happens. Vehicle 150 battery 160 doesn't have enough volts to work the electric components that comprise the starting system, mainly the starter solenoid or solenoids. By leaving something plugged in or left on the operator-user has drained the volts of battery 160, but generally speaking, not drained enough amps such that the present invention may not serve to jump-start. To actually turn the engine over, the operator has to have enough volts in it to engage the solenoid and allow amps to turn the motor.

Thus, by hooking up adapter 110 and fully charged battery 160 from a battery operated power tool to dead battery 160 in vehicle 150, sufficient volts are available to engage solenoid and to allow amps from vehicle 150 battery 160 to start vehicle 150 engine. Battery operated power tool comprises a tool battery 120 with very little amps itself; usually 1.5 to 2.5 amps in current models. The voltage of tool battery 120 from a hand held power tool that can be used for these applications can vary from tool to tool, but generally speaking, any 12 to 24 volt tool battery 120 from a hand held power tool will work because the amps are so small. Unless the device is left hooked-up to vehicle 150 battery 160 for a long period, no damage should occur provided the device is hooked up and used properly.

The described invention has sufficient power and is suitably lightweight (and very portable), this combined with the fact that the clamps and cables are smaller and more flexible than conventional jumper cables (12 volt auxiliary starting system cables) it making it ideal for use with small engines that are seasonally used. For example seasonally used vehicles 150 such as (i.e. ATVs motorcycles, lawnmowers, compressors etc) may be stored in ‘hard to get to’ places for lengthy periods—often leading to dead batteries 160 (i.e. sheds garages, storage buildings, etc.). Not only are these vehicles 150 hard to get at it may also prove difficult to connect clamps from jumper cables or booster packs up to these vehicle's 150 batteries 160 since they are typically located in tight confined places. This can prove to be difficult and frustrating; the present invention serves to solve these problems by being generally user-friendly through the features as described.

Jump start adapter system 100 may comprise a kit including at least one (battery-specific or standardized) adapter 110, tool battery 120, removably connectible gauge wire(s) 130, alligator clips 142, and an instruction manual. Jump start adapter system 100 may be manufactured and provided for sale for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

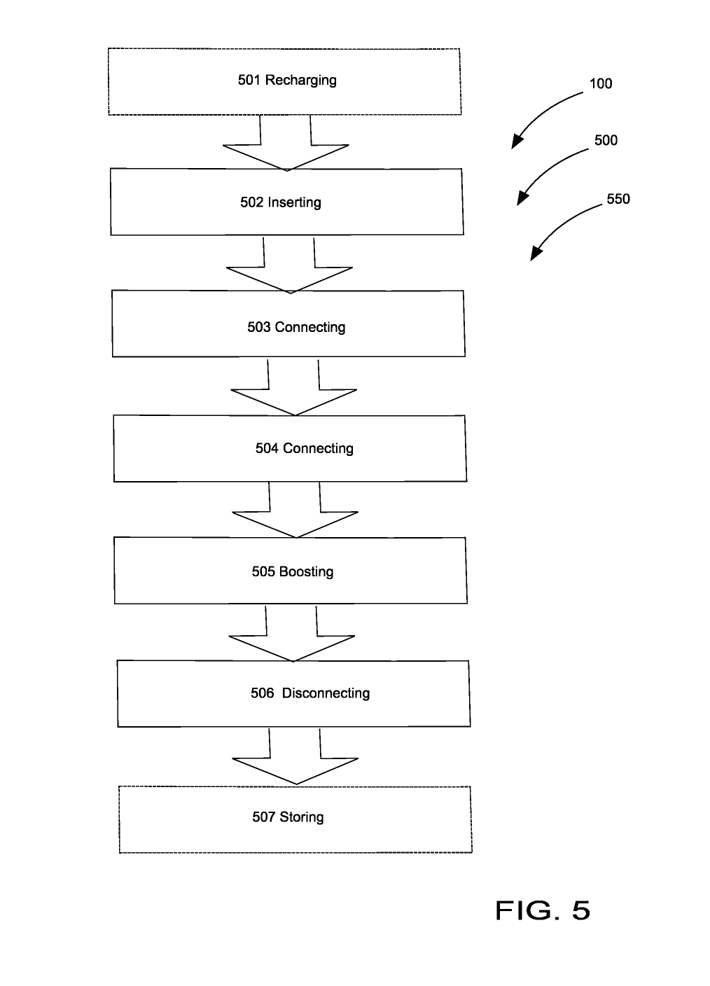

Referring now to FIG. 5, showing a flowchart 550 illustrating a method of use 500 for jump start adapter system 100 according to an embodiment of the present invention of FIGS. 1-4.

A method for using (method of use 500) jump start adapter system 100 may comprise the steps of: step one 501 (optionally) recharging tool battery 120; step two 502 inserting tool battery 120 into adapter 110 or alternately hooking connectible gauge wires 130 to tool battery 120 (in non-hardwired versions); step three 503 connecting a first connectible gauge wire 130 acting as a positive cable from said adapter 110 to a positive terminal on battery 160; step four 504 connecting a second removably connectible gauge wire 130 acting as a negative cable from adapter 110 to a negative terminal on battery 160; step five 505 boosting (vehicle) battery 160 using stored potential chemical energy from tool battery 120; and step six 506 disconnecting first and second removably connectible gauge wire 130 from positive and negative terminals on battery 160 respectively. Optionally, step seven 507 may comprise storing jump start adapter system 100 for a future use.

It should be noted that steps 501 and 507 are optional steps and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A jump start system comprising:
at least one adapter suitable to work in conjunction with at least one tool battery;
said adapter comprising contacts for making electrical connection(s) between said tool battery and said adapter;
a plurality of removably connectible gauge wires each having a proximate and a distal end;
at least one biasing connector;
wherein said distal end(s) of said removably connectible gauge wire(s) are removably connected to said adapter;
wherein said proximate end(s) of said removably connectible gauge wire(s) comprise said biasing connectors to biasingly connect said adapter via said removably connectible gauge wire(s) to said battery; and
wherein said jump start system is usable to jump-start a vehicle battery in communication with an engine.

2. The jump start system of claim 1 wherein said tool battery comprises a portable tool powerer.

3. The jump start system of claim 1 wherein said engine is used to power a movable land vehicle.

4. The jump start system of claim 1 wherein said engine is used to power a non-movable land vehicle.

5. The jump start system of claim 1 wherein said engine is used to power a non-land vehicle.

6. The jump start system of claim 1 wherein one of said removably connectible gauges comprises a red color-coded eight-gauge wire serving as a positive cable.

7. The jump start system of claim 1 wherein one of said removably connectible gauges comprises a black color-coded eight-gauge wire serving as a negative cable.

8. The jump start system of claim 1 wherein at least one of said biasing connectors comprises at least one clip.

9. The jump start system of claim 8 wherein one of said clip(s) comprises a red color-coded alligator clip.

10. The jump start system of claim 8 wherein one of said clip(s) comprises a black color-coded alligator clip.

11. The jump start system of claim 1 wherein said adapter comprises a freestanding unit.

12. The jump start system of claim 3 wherein said adapter is hardwired into said movable land vehicle.

13. The jump start system of claim 12 wherein said adapter is hardwired to said vehicle battery located in said movable land vehicle.

14. The jump start system of claim 12 wherein said adapter is hardwired to a starter motor located in said movable land vehicle.

15. The jump start system of claim 2 wherein said tool battery comprises a rechargeable dry cell battery.

16. The jump start system of claim 1 wherein said vehicle battery comprises a rechargeable wet cell battery.

17. The jump start system of claim 1 wherein said adapter receives said tool battery and comprises a plastic housing.

18. A jump start system comprising:
an adapter suitable to receive at least one tool battery;
wherein said adapter comprises a plastic housing;
wherein said adapter comprises a freestanding unit;
wherein said tool battery comprises a rechargeable dry cell battery;
said adapter comprising contacts for making electrical connection(s) between said tool battery and said adapter;
a plurality of connectible gauge wires each having a proximate and a distal end;
two biasing connectors each having an alligator clip;
wherein said tool battery comprises a portable tool powerer;
wherein said distal end(s) of said connectible gauge wire(s) are removably connected to said adapter;
wherein said proximate end(s) of said connectible gauge wire(s) comprise said biasing connectors to biasingly connect said adapter via said removably connectible gauge wire(s) to said vehicle battery;
wherein one of said connectible gauges comprises a red color-coded eight-gauge wire serving as a positive cable and a black color-coded eight-gauge wire serving as a negative cable;
wherein said vehicle battery comprises a rechargeable wet cell battery;
wherein said jump start system is usable to jump-start an engine;
wherein said engine is used to power a movable land vehicle.

19. The jump start system of claim 18 further comprising a kit including said adapter, said tool battery, said connectible gauge wires, said alligator clips 142, and an instruction manual.

20. A method for using a jump start system comprising the steps of:
recharging a tool battery;
inserting said tool battery into a relationship with an adapter;
connecting a first connectible gauge wire acting as a positive cable from said adapter to a positive battery terminal;
connecting a second connectible gauge wire acting as a negative cable from said adapter to a negative battery terminal;
boosting a vehicle battery using stored potential chemical energy from said tool battery; and
disconnecting said first and second connectible gauge wires from said positive and negative battery terminals respectively.
